(19) United States
(12) Patent Application Publication
(10) Pub. No.: US 2025/0005269 A1
(43) Pub. Date: Jan. 2, 2025

(54) PROMPT BASED CONDITIONING OF A GENERATIVE ARTIFICIAL INTELLIGENCE MODEL

(71) Applicant: ADP, Inc., Roseland, NJ (US)

(72) Inventors: Ameeruddin Ahmed, Weehawken, NJ (US); Maxwell Dixon, New York City, NY (US)

(73) Assignee: ADP, Inc., Roseland, NJ (US)

(21) Appl. No.: 18/759,389

(22) Filed: Jun. 28, 2024

Related U.S. Application Data
(60) Provisional application No. 63/511,500, filed on Jun. 30, 2023.

(51) Int. Cl. G06F 40/174; G06F 40/186; H04L 51/02

(52) U.S. Cl. CPC G06F 40/174; G06F 40/186; H04L 51/02

(57) ABSTRACT

The disclosure provides a technical solution for generating form templates through prompt-based conditioning of a generative artificial intelligence (GAI) model. The solution can identify one or more placeholders for one or more parameters of a form and identify a identify a sample of a template for the form. The solution can generate a prompt for a generative artificial intelligence (GAI) model. The prompt can indicate the one or more placeholders for the one or more parameters, the sample and an instruction to condition a probability distribution of the GAI model to cause the GAI model to generate a computer code for providing the form that arranges the placeholders in accordance with the template. The solution can receive, from the GAI model, the computer code for providing the form comprising the placeholders for the one or more parameters arranged in accordance with the template.

### CROSS-REFERENCES TO RELATED APPLICATIONS

This application claims the benefit of priority under 35 U.S.C. § 119 to U.S. Provisional Patent Application No. 63/511,500, filed Jun. 30, 2023, which is hereby incorporated by reference herein in its entirety.

### TECHNICAL FIELD

This disclosure relates generally to computing technology and, in particular, to conditioning of machine learning (ML) models and prompt-based conditioning of generative artificial intelligence (GAI) models.

### BACKGROUND

Servers can be used to execute computing-based tasks invoked by client devices. However, it can be challenging for devices to efficiently and accurately invoke such tasks for executions due to the large number of varying interface constraints.

### SUMMARY

This disclosure provides technical solutions for prompt-based conditioning of generative artificial intelligence (GAI) models to construct computer code for automated form generation using application programming interface (API) functions. Automating the generation of diverse forms for various clients using GAI models can be a challenge due to the risk of model performance issues, such as hallucinations or drifting, as the range of forms and their variations increase, leading to inaccuracies and unreliable results. Aspects of the technical solutions of this disclosure overcome these and other challenges by implementing automated control and conditioning of prompts, improving the ability of the GAI model to maintain a sharp contextual focus on the intended results when generating code based on user queries. Consequently, the reliability of GAI-based automated form generation is enhanced, errors are reduced or minimized, and the process becomes less compute intensive and more energy efficient.

An aspect of the technical solutions disclosed herein relates to a system. The system can include one or more processors coupled with memory and configured to identify one or more placeholders for one or more parameters of a form. The one or more processors can be configured to identify a sample of a template for the form. The one or more processors can be configured to generate, for a generative artificial intelligence (GAI) model, a prompt indicating the one or more placeholders for the one or more parameters, the sample and an instruction to condition a probability distribution of the GAI model to cause the GAI model to generate a computer code for providing the form that arranges the placeholders in accordance with the template. The one or more processors can be configured to receive, from the GAI model, the computer code for providing the form comprising the placeholders for the one or more parameters arranged in accordance with the template.

An aspect of the technical solutions disclosed herein relates to a method. The method can include identifying, by one or more processors coupled with memory, one or more placeholders for one or more parameters of a form. The method can include identifying, by the one or more processors, sample of a template for the form. The method can include generating, by the one or more processors for a generative artificial intelligence (GAI) model, a prompt indicating the one or more placeholders for the one or more parameters, the sample and an instruction to condition a probability distribution of the GAI model to cause the GAI model to generate a computer code for providing the form that arranges the placeholders in accordance with the template. The method can include receiving, by the one or more processors from the GAI model, the computer code for providing the form comprising the placeholders for the one or more parameters arranged in accordance with the template.

An aspect of the technical solutions disclosed herein relates to a non-transitory computer readable medium storing program instructions for causing at least one processor to identify one or more placeholders for one or more parameters of a form. The instructions can be for identifying a sample of a template for the form. The instructions can be for generating, for a generative artificial intelligence (GAI) model, a prompt indicating the one or more placeholders for the one or more parameters, the sample and an instruction to condition a probability distribution of the GAI model to cause the GAI model to generate a computer code for providing the form that arranges the placeholders in accordance with the template. The instructions can be for receiving, from the GAI model, the computer code for providing the form comprising the placeholders for the one or more parameters arranged in accordance with the template.

### BRIEF DESCRIPTION OF THE DRAWINGS

Aspects of the technical solutions are described in the detailed description which follows, in reference to the noted plurality of drawings by way of non-limiting examples of exemplary embodiments of the technical solutions.

FIG. 1 is an illustrative architecture of a computing system implemented in embodiments of the technical solutions.

FIG. 2 shows an exemplary cloud computing environment in accordance with aspects of the technical solutions.

FIG. 3 shows an example block diagram of a system for prompt-based conditioning of a GAI model to produce a GAI model generated computer code for automated formation of templates, in accordance with aspects of the technical solutions.

FIG. 4 shows an example of a data processing system for prompt-based conditioning of a GAI model via an AI assistant utilizing API responses from API functions.

FIG. 5 relates to examples of prompts that can be used, in accordance with aspects of the technical solutions.

FIG. 6 relates to an example of an output template that can be used, in accordance with aspects of the technical solutions.

FIG. 7 relates to an example process flow for prompt-based conditioning of a GAI model to produce a GAI model generated computer code for automated formation of templates, in accordance with aspects of the technical solutions.

FIGS. 8-9 relate to examples of output templates, in accordance with aspects of the technical solutions.

FIGS. 10-11 relate to examples of user interfaces and corresponding data inputs, in accordance with aspects of the technical solutions.

FIGS. 12-16 illustrate examples of user interfaces of an application for a data processing system allowing the user to create or edit various values or parameters for the prompt-based GAI model conditioning using AI assistant and APIs.

FIG. 17 illustrates a flow diagram of a method for providing prompt-based conditioning of a GAI model for automated generation of forms.

### DETAILED DESCRIPTION OF ASPECTS OF THE INVENTION

Aspects of the technical solutions of this disclosure are directed to prompt-based conditioning of generative artificial intelligence (GAI) models for constructing computer code for automated generation of forms using application programming interface (API) functions. Utilizing GAI models to automate generation of diverse forms for various clients or entities can be a challenge. As the range of forms broadens and the number of variations in which the forms can be filled increases, the likelihood of GAI model performance issues, such as hallucinations or drifting can also increase, leading to inaccuracies and unreliable results.

The technical solutions of this disclosure overcome these and other challenges by implementing automated control and conditioning of prompts to the GAI model, to sharpen the contextual understanding of the GAI model when generating computer code based on the user queries. In doing so, the technical solutions improve the reliability and minimize the errors in GAI model-based automated form generation, decreasing the time and the computational resources it takes to complete the form generating tasks and improving the system's energy efficiency.

The technical solutions of this disclosure utilize automated API-initiated functions implement prompt-based conditioning of a Generative AI (GAI) model to produce computer code for automated creation of templates/forms tailored to HR service tasks utilizing employee data. By generating detailed prompts that indicate placeholders and their corresponding parameters, alongside samples and instructions to adjust the GAI model's probability distribution within a desired operational context, the system facilitates the GAI model to generate the necessary computer code for producing customized forms based on the desired template. This prompt-based conditioning approach allows for the timely and efficient creation of computer code to automate template formation for a range of HR service tasks.

With the present solution, the prompt instructions can guide the GAI model's operation by defining the adjusted probability distribution within the desired operational context, prompting the model to generate the targeted computer code. As a result, organizations can streamline their HR service tasks by automating the creation of templates that incorporate employee data while adhering to specific requirements and guidelines. By facilitating prompt-based conditioning of the GAI model, this solution improves the generation of tailored computer code, enabling efficient and accurate template formation for diverse HR or payroll service tasks.

Aspects of the technical solutions are directed to integrating APIs (Application Programming Interfaces) with an AI assistant using a chatbot interface. The system can convert API specifications into executable functions and create an AI assistant that can use a Large Language Model (LLM) that supports function calling. The API specifications can be specifications for a generative AI platform that define the protocols and structures allowing integration and utilization of AI capabilities (e.g., natural language processing, machine learning, and image recognition) for tasks (e.g., text generation, code generation, and data analysis) within the technical solutions. The AI assistant can be equipped with (e.g., include, be configured with, access, or otherwise utilize) converted API functions and can be accessible to a client device via a chatbot interface. Client (e.g., user) interactions with the chatbot can be processed by the AI assistant, which can generate function calls based on the query input. These function calls can be mapped to execute the corresponding APIs, and the results can be sent back to the AI assistant. The AI assistant can then formulate a response and send it back to the user via the chatbot interface. In doing so, the technical solutions can provide a seamless integration between APIs and an AI assistant, allowing users to interact with APIs using natural language through a chatbot interface, simplifying the process of accessing and utilizing APIs.

The technical solutions of this disclosure are also directed to integrating human resources (HR) application programming interfaces (APIs) with an artificial intelligence (AI) assistant via a chatbot interface. The system can convert API specifications from various applications (e.g., HR applications), including but not limited to payroll, benefits administration, talent management, and workforce analytics, into executable functions. The technical solutions can utilize various types of applications to implement API specifications. The technical solutions can create or provide an AI assistant using an LLM that supports function calling and that can be trained using HR domain knowledge.

The technical solutions can include a system that can include an API Converter that can transforms HR-specific API specifications into executable functions compatible with the AI assistant. The system can include an AI Assistant creator that initializes the AI assistant with converted functions and HR-specific knowledge. The system can include a chatbot interface for user interaction. The system can include a function call mapper that translates AI-generated function calls to API endpoints. The system can include result processor that formats API responses for the AI assistant and a fine-tuning dataset of HR-related tasks and corresponding function calls. The system can include a contextual memory module that can maintain user session information and HR-specific context. The system can include a compliance checker that can verify that all AI-generated responses adhere to relevant HR regulations and company policies. The system can include multi-tenant architecture that allows secure isolation of data and functions for different organizations. The system can include an adaptive learning engine that continuously improves the AI assistant's performance based on user interactions and feedback.

The method of the technical solutions can include converting HR API specifications, creating and initializing the AI assistant, processing user input, generating and mapping function calls, executing API requests, processing results, formulating responses, and continuously fine-tuning the AI assistant. The system can provide a seamless integration between HR APIs and an AI assistant, allowing HR professionals and employees to interact with various HR systems using natural language through a chatbot interface. The invention simplifies access to HR-related data and processes while ensuring compliance with relevant regulations and policies.

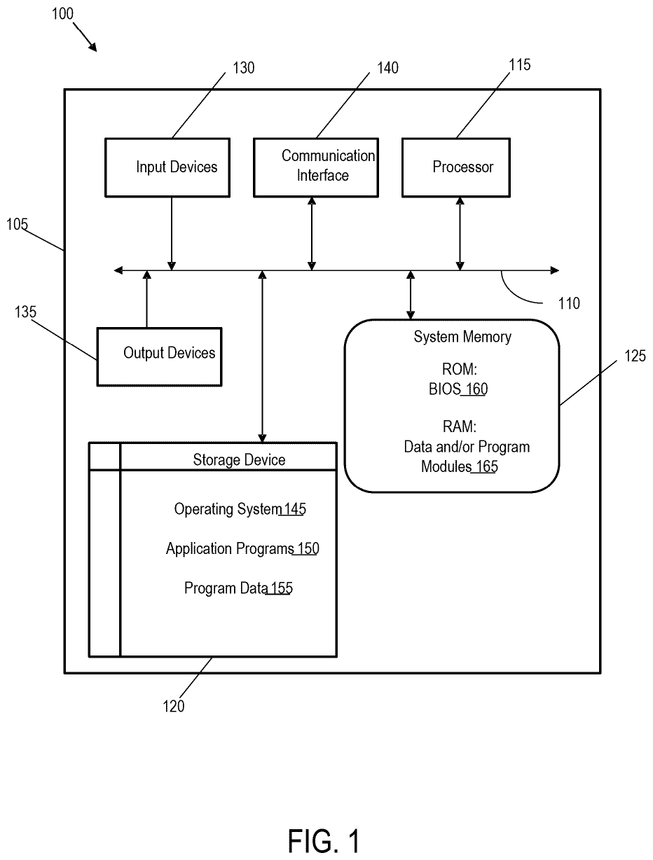

FIG. 1 is an illustrative architecture of a computing system 100 implemented in embodiments of the technical solutions. The computing system 100 is only one example of a suitable computing system and is not intended to suggest any limitation as to the scope of use or functionality of the disclosure. Also, computing system 100 should not be interpreted as having any dependency or requirement relating to any one or combination of components illustrated in computing system 100.

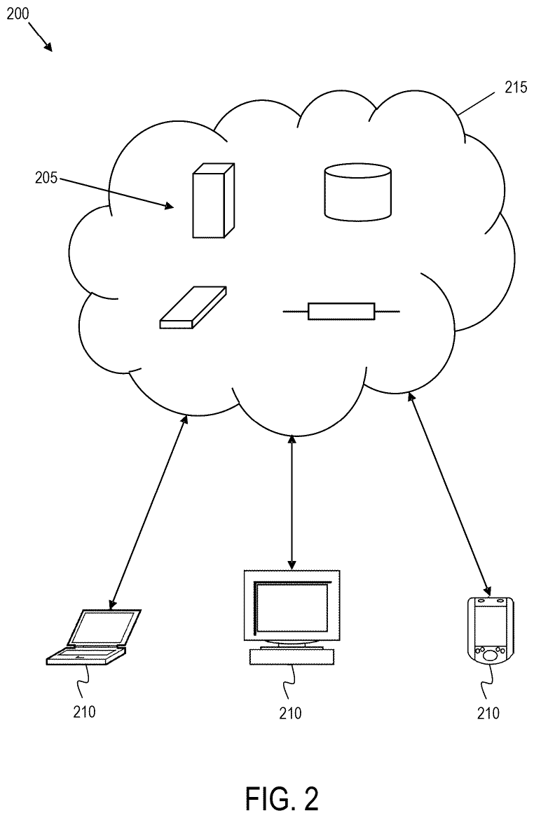

As shown in FIG. 1, computing system 100 includes a computing device 105. The computing device 105 can be resident on a network infrastructure such as within a cloud environment as shown in FIG. 2 or may be a separate independent computing device (e.g., a computing device of a third-party service provider). The computing device 105 may include a bus 110, a processor 115, a storage device 120, a system memory (hardware device) 125, one or more input devices 130, one or more output devices 135, and a communication interface 140.

The bus 110 permits communication among the components of computing device 105. For example, bus 110 may be any of several types of bus structures including a memory bus or memory controller, a peripheral bus, and a local bus using any of a variety of bus architectures to provide one or more wired or wireless communication links or paths for transferring data or power to, from, or between various other components of computing device 105.

The processor 115 may be one or more processors or microprocessors that include any processing circuitry operative to interpret and execute computer readable program instructions, such as program instructions for controlling the operation and performance of one or more of the various other components of computing device 105. In embodiments, processor 115 interprets and executes the processes, steps, functions, or operations of the technical solutions, which may be operatively implemented by the computer readable program instructions.

For example, processor 115 provides an enterprise-wide security approach with all stakeholders (e.g., Dev teams, leadership, CSO office, etc.) with a set of various security scanner types and information sources integrated into a single tool. In embodiments, the processor 115 uniformly integrates or packages existing scanner types into a single tool that standardizes and visually displays the output over different development teams for different scanner types. The scanner types which are packaged into the integrated security tool can capture specific requirements of the different teams, i.e., ensures that the tools support varied team development methodologies and different tech stacks to capture required security vulnerabilities. The processor 115 also establishes a regular feedback mechanism and can be used to develop a process for remediation timelines and priority including at risk vulnerabilities.

In embodiments, processor 115 may receive input signals from one or more input devices 130 or drive output signals through one or more output devices 135. The input devices 130 may be, for example, a keyboard, touch sensitive user interface (UI). The output devices 135 can be, for example, any display device, speaker, printer, or any other device that can be used to present or provide output.

The storage device 120 may include removable/non-removable, volatile/non-volatile computer readable media, such as, but not limited to, non-transitory media such as magnetic or optical recording media and their corresponding drives. The drives and their associated computer readable media provide for storage of computer readable program instructions, data structures, program modules and other data for operation of computing device 105 in accordance with the different aspects of the technical solutions. In embodiments, storage device 120 may store operating system 145, application programs 150, and program data 155 in accordance with aspects of the technical solutions.

The system memory 125 may include one or more storage mediums, including for example, non-transitory media such as flash memory, permanent memory such as read-only memory (“ROM”), semi-permanent memory such as random-access memory (“RAM”), any other suitable type of storage component, or any combination thereof. In some embodiments, an input/output system 160 (BIOS) including the basic routines that help to transfer information between the various other components of computing device 105, such as during start-up, may be stored in the ROM. Additionally, data or program modules 165, such as at least a portion of operating system 145, application programs 150, or program data 155, that are accessible to or presently being operated on by processor 115 may be contained in the RAM.

The communication interface 140 may include any transceiver-like mechanism (e.g., a network interface, a network adapter, a modem, or combinations thereof) that enables computing device 105 to communicate with remote devices or systems, such as a mobile device or other computing devices such as, for example, a server in a networked environment, e.g., cloud environment. For example, computing device 105 may be connected to remote devices or systems via one or more local area networks (LAN) or one or more wide area networks (WAN) using communication interface 140.

As discussed herein, computing system 100 may be configured to integrate different scanner types into a single workbench or tool. This allows developers and other team members a uniform approach to assessing security vulnerabilities in a code throughout the enterprise. In particular, computing device 105 may perform tasks (e.g., process, steps, methods or functionality) in response to processor 115 executing program instructions contained in a computer readable medium, such as system memory 125. The program instructions may be read into system memory 125 from another computer readable medium, such as data storage device 120, or from another device via the communication interface 140 or server within or outside of a cloud environment. In embodiments, an operator may interact with computing device 105 via the one or more input devices 130 or the one or more output devices 135 to facilitate performance of the tasks or realize the end results of such tasks in accordance with aspects of the technical solutions. In additional or alternative embodiments, hardwired circuitry may be used in place of or in combination with the program instructions to implement the tasks, e.g., steps, methods or functionality, consistent with the different aspects of the technical solutions. Thus, the steps, methods or functionality disclosed herein can be implemented in any combination of hardware circuitry and software.

FIG. 2 shows an example cloud computing environment 200 in accordance with aspects of the disclosure. In embodiments, one or more aspects, functions or processes described herein may be performed or provided via cloud computing environment 200. As depicted in FIG. 2, cloud computing environment 200 includes cloud resources 205 that are made available to client devices 210 via a network 215, such as the Internet. Cloud resources 205 may be on a single network or a distributed network. Cloud resources 205 may be distributed across multiple cloud computing systems or individual network enabled computing devices. Cloud resources 205 can include a variety of hardware or software computing resources, such as servers, databases, storage, networks, applications, and platforms that perform the functions provided herein including storing code, running scanner types and provided an integration of plural scanner types into a uniform and standardized application, e.g., display.

Client devices 210 may comprise any suitable type of network-enabled computing device, such as servers, desktop computers, laptop computers, handheld computers (e.g., smartphones, tablet computers), set top boxes, and network-enabled hard drives. Cloud resources 205 are typically provided and maintained by a service provider so that a client does not need to maintain resources on a local client device 210. In embodiments, cloud resources 205 may include one or more computing system 100 of FIG. 1 that is specifically adapted to perform one or more of the functions or processes described herein.

Cloud computing environment 200 may be configured such that cloud resources 205 provide computing resources to client devices 210 through a variety of service models, such as Software as a Service (SaaS), Platforms as a service (PaaS), Infrastructure as a Service (IaaS), or any other cloud service models. Cloud resources 205 may be configured, in some cases, to provide multiple service models to a client device 210. For example, cloud resources 205 can provide both SaaS and IaaS to a client device 210. Cloud resources 205 may be configured, in some cases, to provide different service models to different client devices 210. For example, cloud resources 205 can provide SaaS to a first client device 210 and PaaS to a second client device 210.

Cloud computing environment 200 may be configured such that cloud resources 205 provide computing resources to client devices 210 through a variety of deployment models, such as public, private, community, hybrid, or any other cloud deployment model. Cloud resources 205 may be configured, in some cases, to support multiple deployment models. For example, cloud resources 205 can provide one set of computing resources through a public deployment model and another set of computing resources through a private deployment model.

In embodiments, software or hardware that performs one or more of the aspects, functions or processes described herein may be accessed or utilized by a client (e.g., an enterprise or an end user) as one or more of a SaaS, PaaS and IaaS model in one or more of a private, community, public, and hybrid cloud. Moreover, although this disclosure includes a description of cloud computing, the systems and methods described herein are not limited to cloud computing and instead can be implemented on any suitable computing environment.

Cloud resources 205 may be configured to provide a variety of functionality that involves user interaction. Accordingly, a user interface (UI) can be provided for communicating with cloud resources 205 or performing tasks associated with cloud resources 205. The UI can be accessed via a client device 210 in communication with cloud resources 205. The UI can be configured to operate in a variety of client modes, including a fat client mode, a thin client mode, or a hybrid client mode, depending on the storage and processing capabilities of cloud resources 205 or client device 210. Therefore, a UI can be implemented as a standalone application operating at the client device in some embodiments. In other embodiments, a web browser-based portal can be used to provide the UI. Any other configuration to access cloud resources 205 can also be used in various implementations.

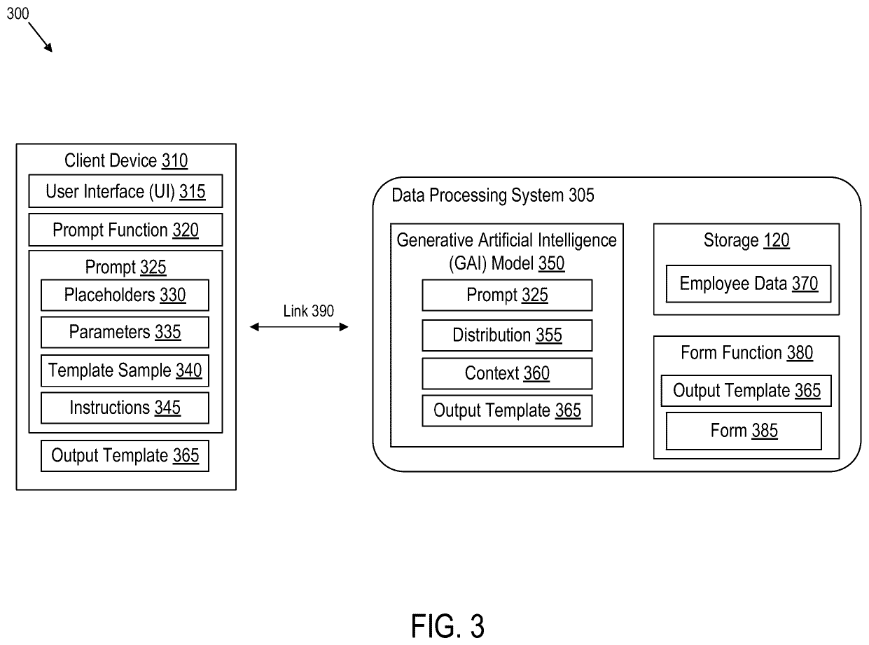

FIG. 3 shows an example 300 of a block diagram of a system for prompt-based conditioning of a GAI model to produce a GAI model generated computer code for automated formation of templates. Example system 300 can include one or more of client devices 310 communicatively coupled with one or more data processing systems 305 via one or more links 390. Data processing system 305 can include one or more of generative artificial intelligence (GAI) models 350, storages 120 and form functions 380. A form function 380 can include or generate one or more of output templates 365 and forms 385. A storage 120 can store one or more employee data 370. A GAI model 350 can include or utilize on or more prompts 325, probability distributions 355, contexts 360 and output templates 365.

The client device 310 (e.g., a computer station) can provide a user interface 315 to allow the user to use prompt function 320 to generate a prompt 325 in order to generate an output template 365 using the generative artificial intelligence (GAI) model 350. Prompt 325 can include placeholders 330, parameters 335, template sample 340 and instructions 345. GAI model 350 can receive the prompt 325 from the client device 310 and can adjust its distribution 355 to be focused in accordance with a context 360. GAI model 350 can utilize the prompt 325 adjusting its probability distribution 355 and the context 360 to provide an output template 365 (e.g., computer code for generating forms 385). System 300 can include a storage 120 storing employee data 370 and a form function 380 for using the output templates 365 from the GAI model 350 to generate or produce forms 385 with the placeholders 330, and parameters 335 indicating employee data 370.

Data processing system 305 can include any combination of hardware and software for prompt-based conditioning of a GAI model 350. Data processing system 305 can include computer code, functions, data and instructions stored in a memory 125 or storage 120 and configured to be accessed by one or more processors 115 to implement any functionalities associated with prompt-based conditioning of a GAI model 350. Data processing system 305 can be implemented on a computing device, such as a server implemented in a computing system 100, one or more physical or virtual devices or a cloud-based environment, such as the cloud of example 200 in FIG. 2.

Data processing system 305 can include a form function 380 for utilizing an output template (e.g., computer code from a GAI model 350) to formulate, form or generate a form 385 (e.g., requested by the client device 310). Form function 380 can utilize GAI model 350 (e.g., via an AI assistant) to leverage prompts 325 and contexts 360 (e.g., information from documents and other relevant data) to prompt the GAI model to generate output template 365 or forms 385. Data processing system 305 can include or provide an application with a user interface 315 to allow the user to access (e.g., via chatbot interface) functionality of the data processing system 305 for prompt-base conditioning of GAI model 350 using AI assistant and API functionalities. The application can include one or more user interfaces 315 allowing the user to make selections to configure operations of any one or more parameters, values, data or inputs for any one or more of: AI assistant 410, function call mapper 420, API functions 425, result processors 435 and form functions 380.

Data processing system 305 can communicate via one or more client devices 310 via communication links 390. A communication link 390 can include any combination of wired or wireless connections for exchanging communications or data between the client device 310 and the data processing system 305. A communication link can include a wireless connection between the devices, such as a wireless local area network (WLAN) connection (e.g., via a Wi-Fi router), or a connection via a cellular network, such as a network 205, or the internet.

A client device 310 can be any computing device, such as a personal computer or a workstation that a user (e.g., employee of the enterprise) can use to access a user interface 315. User interface 315 can include any computing interface (e.g., a website, a web page, a chatbot, or any graphical user interface having a selection of menus and options) that the user can access and use, via the client device 310, to access the prompt function 320 and formulate, draft, or create the prompt 325.

Prompt function 320 can include any combination of hardware and software that can be used to create a prompt 325. Prompt function 320 can include or provide instructions, functions or computer code for generating a prompt. Prompt function 320 can include or provide templates or tools for a user to identify, define or include any placeholders 330, parameters 335, templates samples 340 or instructions 345.

Prompt 325 can include any text, including a series of characters, instructions or data, which can instruct a Generative AI model 350 to operate in accordance with a particular context 360 or probability distribution 355. Prompt 325 can include a specific input or instruction (e.g., or a set of instructions) that can influence, specify, adjust or guide the output of the GAI model 350 by providing or indicating context (e.g., context 360), constraints or desired outcome (e.g., desired type, form of output).

Placeholders 330 can include any designated positions or markers that indicate where dynamic content or data (to be provided) should be inserted or displayed within a structure of a form 385. Placeholders 330 can indicate a location of a particular parameter 335. Parameters 335 corresponding to the placeholders 330 can correspond to, or include any employee data 370, such as employee names, addresses, bank account information, health information, weekly, biweekly, monthly or annual salary amounts, employment tax information or data or any other user-specific information, confidential or public.

Template sample 340 can include a sample of an output template 365. Template sample 340 can include one or more sample keywords, instructions, data, information or other information describing for the GAI model 350 the type of output template 365 to produce. Template sample 340 can include computer code information, variable names, placeholders 330 or parameters 335 or instructions 345.

Instructions 345 can include any command or guidance provided as input to direct the GAI model's behavior or output generation according to desired criteria or objectives. Instruction 345 can be a series of characters, text or keywords within a prompt to a GAI model 350 that can be, or serve, as a directive that guides the GAI model 350 to generate a specific output within a defined context 360 or with desired characteristics (e.g., format and type of output template 365).

Output template 365 can include any output from the GAI model 350 tailored to, conditioned on, or adjusted, created or designed responsive to, the prompt 325. Output template 365 can include a computer code to be input into a form function 380 to provide a form 385. Output template 365 can include a computer code comprising instructions in Goland, HTTP, JavaScript or other computer languages to cause the form function 380 to output the form 385.

Generative Artificial Intelligence (GAI) model 350 can include any machine learning (ML) or artificial intelligence (AI) model designed to generate content or new content, such as text, images, or code, by learning patterns and structures from existing data. GAI model 350 can be any model, a computational system or an algorithm that can learn patterns from data (e.g., chunks of data from various input documents, computer code, templates, forms, etc.) and make predictions or perform tasks without being explicitly programmed to perform such tasks. GAI model 350 can refer to or include a large language model. GAI model 350 can be trained using a dataset of documents (e.g., text, images, videos, audio or other data). GAI model 350 can be designed to understand and extract relevant information from the dataset. GAI model 350 can leverage natural language processing techniques and pattern recognition to comprehend the context and intent of the prompt 325, match it with relevant information in the training data, and generate a response that addresses the query.

GAI model 350 can be built using deep learning techniques, such as neural networks, and can be trained on large amounts of data. GAI model 350 can be designed, constructed or include a transformer architecture with one or more of a self-attention mechanism (e.g., allowing the model to weigh the importance of different words or tokens in a sentence when encoding a word at a particular position), positional encoding, encoder and decoder (multiple layers containing multi-head self-attention mechanisms and feedforward neural networks). For example, each layer in the encoder and decoder can include a fully connected feed-forward network, applied independently to each position. The data processing system 305 can apply layer normalization to the output of the attention and feed-forward sub-layers to stabilize and improve the speed with which the GAI model 350 is trained. The data processing system 305 can leverage any residual connections to facilitate preserving gradients during backpropagation, thereby aiding in the training of the deep networks. Transformer architecture can include, for example, a generative pre-trained transformer, a bidirectional encoder representations from transformers, transformer-XL (e.g., using recurrence to capture longer-term dependencies beyond a fixed-length context window), text-to-text transfer transformer,

GAI model 350 can be trained (e.g., by a model training function) using any text-based dataset by converting the text data from the input dataset documents into numerical representations (e.g., embeddings) of the chunks of those documents. These embeddings can capture the semantic meaning of words, paragraphs, pages or sentences, depending on the size and type of chunks of dataset documents are parsed into. Embeddings can be used to represent and organize the dataset documents within a high-dimensional space (e.g., embedding space), where similar documents or concepts are located closer together. Embedding space can include a multi-dimensional vector space where each data point is represented by an embedding.

Through training, including via prompts 325, the GAI model 350 can learn, or adjust its understanding of mapping the embeddings to particular issues (e.g., particular types of template outputs, particular form related functionalities, placeholder and variable relations and more), by adjusting its internal parameters. Internal parameters can include numerical values of the GAI model 350 that the model learns and adjusts during training (e.g., and in response to prompts 325) to optimize its performance and make more accurate predictions. Such training and can include iteratively presenting the various data chunks or documents of the dataset (e.g., or their chunks, embeddings) to the GAI model 350, comparing its predictions with the known correct answers, and updating the model's parameters to minimize the prediction errors. By learning from the embeddings of the dataset data chunks, the GAI model 350 can gain the ability to generalize its knowledge and make accurate predictions or provide relevant insights when presented with prompts 325.

Generative artificial intelligence (GAI) model 350 can include any ML or AI model or a system that can learn from a dataset to generate new content (e.g., text or images) that resembles a distribution 355 of the training dataset. A distribution 355 of a dataset can include an underlying probability distribution representing the patterns and characteristics of the data used to train a GAI model 350. For example, a training data distribution can represent statistical properties of a text data (e.g., text corpus), such as the frequency of words, the co-occurrence of terms, and the overall structure of the language used in the training dataset. GAI model 350 can include the functionality to utilize such a probability distribution of patterns and characteristics to generate new responses (e.g., predictions) that were not present in the dataset.

GAI model 350 can generate, responsive to the prompt 325, output templates 365 that can include computer code for generating forms 385. Output templates 365 can include computer code, instructions, variables, keywords, functions and parameters implemented in Goland, HTML, JavaScript, PHP, Python or any other computer language. Output templates 365 can include placeholders 330 and their corresponding parameters 335 referencing or including employee data 370, such as employee payroll information, weekly or monthly wages, bank account, 401k or IRA investment accounts of the employee or any other employee data 370.

Form function 380 can include any combination of hardware and software for generating forms 385. Form function 380 can include the functionality for extracting or using employee data 370 stored in storage 120 (e.g., a database or similar structures in storage 120) and produce forms 385 in accordance with the templates 365. Form function 380 can use the output template 365 (e.g., computer code generated by the GAI model 350) as an input into the form function 380, access any employee data 370 at storage 120 according to the template 365 (e.g., placeholders 330, parameters 335 and similar) and fill in the placeholders 330 or parameters 335 using the employee data 370, according to the output template 365. Form function 380 can provide a form 385.

Form 385 can include any structured document or a digital interface used to collect, organize, and submit information through predefined fields and placeholders. Form 385 can include a template with designated fields used for entering and collecting specific data systematically. Form 385 can include any document or form, such as a payroll document (e.g., a paystub), W2 form, forms for employees to use for federal or state income taxes, forms for medical leave, health insurance or medical purposes or forms for enterprise, employer or employee purposes.

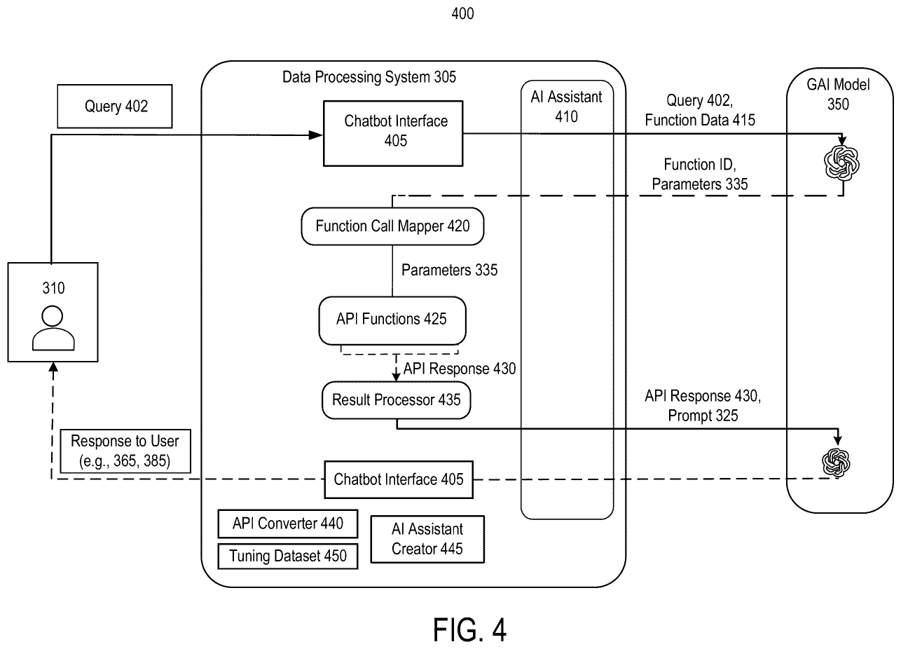

FIG. 4 illustrates an example 400 of a data processing system 305 using an AI assistant and a chatbot to identify API functions whose API responses can be used as inputs into GAI model 350 for improved model operation and reliability. In example 400, data processing system 305 can be communicatively coupled with one or more client devices 310 and interact or utilize one or more GAI models 350. A data processing system 305 can include one or more of chatbot interfaces 405 for communicating with a client device 310, AI assistants 410 for interfacing and assisting with operations of the GAI model 350, function call mappers 420 for mapping API functions 425 to be executed and result processors 435 for processing API responses 430 into a format suitable for AI assistant 410. Data processing system 305 can also include one or more of: API assistant creators 445 for creating AI assistants 410, API converters 440 for converting API specifications into API functions 425 (e.g., API endpoints generating API responses 430), and tuning datasets 450 for improving AI assistant's ability to generate accurate function calls based on the user input.

Data processing system 305 can be implemented using one or more processors 115 coupled with memory (e.g., 125) that can include or store computer code, data or parameters for any operations or functionalities of the data processing system 305. Data processing system 305 can include any functionalities discussed in connection with FIG. 3, including form function 380. The form function 380 can be implemented, for example, using any combination of features and functionalities of the AI assistant 410, function call mapper 420, API functions 425 and result processor 435.

Data processing system 305 can utilize a chatbot interface 405 to receive a query 402 (e.g., a user prompt or a message on a chatbot interface 405) from a client device 310. For instance, a data processing system 305 can generate, using an AI assistant 410 for the GAI model 350 and based on the query 402, the one or more placeholders 330 and the sample of the template 340 for the GAI model. For example, the sample of the template 340 can be generated, defined or specified using one or more API responses 430 that can provide information on any number of portions of the template of the form 385 to generate by the GAI model 350.

The data processing system 305 can receive, using the AI assistant 410 for the GAI model 350, one or more identifiers (e.g., function IDs) of one or more API functions 425 of a plurality of API functions 425 generated by the API converter 440. The identifiers can include function calls (e.g., API calls) or information operations to be implemented by the API functions 425 from which the function call mapper 420 can identify the API functions 425 to which it can issue API calls. The data processing system 305 can receive, along with the function identifiers, one or more parameters (e.g., 335) for operating or executing the API functions 425.

The data processing system 305 can generate one or more API responses 430 by executing the one or more identified API functions 425 using the one or more parameters (e.g., 335). For instance, using parameters on user identifier or type of form to generate or one or more entries for a given form, an API function 425 can generate a portion of the form, associate a particular parameter 335 with a placeholder 330 and provide a portion of a template sample 340 or instructions 345 for generating or completing the prompt 325.

The data processing system 305 can provide any information from the API responses 430 generated by the API functions 425 to the result processor 435. The result processor 435 can convert the API responses 430 into form or format of data, or generate a collection of data, to provide to AI assistant 410. The AI assistant 410 can generate the prompt 325, from the processed API responses 430 provided by the result processor 435. The prompt 325 can be provided by the AI assistant to the GAI model 350 for processing. The data processing system 305 can receive from the GAI model 350 (e.g., via AI assistant 410), the computer code (e.g., 365 or 385) responsive to the API response 430 or the prompt 325 input into the GAI model.

In example 400, a client device 310 can provide a query 402 to a chatbot interface 405 of a data processing system 305. The query 402 can include a text from client device 310, such as a user request that can include any information or data for generating the output template 365 or form 385. The query 402 can include a prompt 325 (e.g., as discussed in connection with example 300) or any portion of a prompt 325 in a description of a task to be implemented. The query 402 can include any portion or information corresponding to the prompt 325, such as information on any placeholders 330, parameters 335, template samples 340 and instructions 345. Query 402 can include a partial information on each portion of the prompt 325, such as any information identifying, suggesting or corresponding to placeholders 330, parameters 335, template samples 340 and instructions 345, which can be included or described in a query text format. The query may include the text describing of the form to implement, the name of the entity (e.g., person for whom the form is filled), or any information or data about the person or the form.

The query 402 can be received by the AI assistant 410. The AI interface 410 can be initiated by the AI assistant creator 445 and tuned by the tuning dataset 450 to improve the relationships between API-related tasks and the corresponding function calls. The AI assistant 410 can generate or identify function data 415, such as data that can include steps or actions to implement (e.g., tasks to complete the form). The function data 415 can include information indicative of the functions to implement or functionality to utilize in order to implement the query 402. The function data 415 can include a list of all the API functions 425 available for the GAI model 350 to use or select from based on the query 402. The function data 415 can include information or data from documentation indicative of context 360 (e.g., information about the type of form to generate and any information on parameters 335, placeholders 330, instructions 345 or information about template sample 340), which the GAI model 350 can utilize to generate function identifiers and parameters 335. The AI assistant 410 can utilize the GAI model 350 to generate the function data 415 based on the query 402 (e.g., the name of the person for whom the form is generated, information about the form, metadata associated with the information included in the user query or any parameters of a prompt 325). Function data 415 and the query 402 can be provided to the GAI model 350, instructing the GAI model 350 to identify one or more API functions 425 to run or execute.

Using the function data 415 and query 402 received from the AI assistant 410, the GAI model 350 can determine and provide a function identifier (e.g., identifier of an API function 425) and parameters 335 to use for the execution of the identified API function 425. The AI assistant 410 can provide the function identifier (e.g., for API calls) and the parameters 335 generated by GAI model 350 to the function call mapper 420 to identify or map the API function 425 according to the function ID and can use the parameters 335 to run or execute the API function 425. The API functions 425 can be generated by the API converter 440 that can convert API specification (e.g., files or code specifying specific tasks to execute for implementing one or more portions of form generation) into API functions 425. The API function(s) 425 identified by the GAI model 350 can use the parameters 335 as inputs to run their API function code and provide one or more API responses 430.

The result processor 435 can receive the API responses 430 from the API functions 425 and process the API responses 430 into a format suitable for the AI assistant 410. Once formatted according to the AI assistant format (e.g., format understood by the GAI model 350), the API response(s) 430 and the query 402 can be used to generate the prompt 325 that can be input into the GAI model 350. For example, the formatted API responses 430 and information from the query 402 can be used by the result processor 435 or AI assistant 410 to generate the prompt 325 that can be used to condition, instruct, focus or fine-tune the operation and execution of the GAI model 350. By using API responses 430 from the API functions 425 (e.g., executed portions of the form, particular type of inputs, parameters, data or entries for the form can be specified or provided), the GAI model 350 can fine-tune, adjust, narrow, focus or customize the probability distribution (e.g., probability curve) of its determination to a shortened range of possibilities, increasing the chance of a correct and reliable response and decreasing the chance of hallucination or drifting.

Once executed by the GAI model 350, the response from the GAI model 350 can include any combination of output template 365 or form 385. The AI assistant 410 can receive the response (e.g., 365 or 385) from the GAI model 350 and provide it to the client device 310 via a chatbot interface 405. In doing so, the data processing system 305 can allow the user to more accurately, efficiently and reliably generate and auto-populate the output templates 365 and forms 385 using a chatbot interface 405 and without having to provide or generate complete and detailed prompts 325.

API converter 440 can include any combination of hardware and software for converting API specifications into executable functions (e.g., API functions 425). API converter 440 can include a module or function for converting API specifications, such as those that can be provided or implemented using OpenAPI, into executable functions (e.g., API functions 425). The API converter 440 can parse the API specifications (e.g., documents or files specifying operations to be implemented by API functions 425) and generate function signatures and implementations (e.g., API functions 425) compatible with the AI assistant 410. For instance, the API converter 440 can convert API specifications into API functions 425 that are executable functions configured to implement specific tasks with respect to formation of any part of the output templates 365 or forms 385.

For example, the API converter 440 can parse API specifications such as OpenAPI and generate function signatures and implementations compatible with the AI assistant, providing improved accuracy with respect to the execution of API endpoints (e.g., API functions 425). API converter 440 can convert abstract API specifications into actionable code that interfaces with the AI assistant 410 and external API functions 425 that can facilitate adjustment or narrowing of the probability distribution around the requested or target output (e.g., 365 or 385 specified by the user in the prompt 325).

AI Assistant creator 445 can include any combination of hardware and software for creating or generating an AI assistant 410. AI assistant creator 445 can include a function or a module that creates an AI assistant 410 using an LLM (e.g., GAI model 350) that supports function calling operations, such as function calling of API functions to implement specific form-generation related tasks (e.g., creating a portion of a form, a format of the form, a layout of the form or aligning parameters with placeholders). The AI assistant creator 445 can create or initialize the AI assistant 445 based on the converted functions or specifications for the API operations.

AI Assistant creator 445 can initialize the AI assistant 410 with converted functions to interpret user queries and generate responses. AI assistant creator 445 can initialize or create an AI assistant 410 using a GAI model 350 and API functions 425. AI assistant creator 445 can utilize tuning dataset 450 to create the AI assistant 410 to create relationships between the API-related tasks and the API functions 425.

The AI assistant 410 generated by the AI creator 445 can be initialized using the converted API functions 425 to allow the AI assistant 410 to understand and execute API-related tasks. AI assistant 410 can convert outputs from the data processing system 305 (e.g., result processor 435) in the form, format or language used by the GAI model 350. AI assistant 410 can convert inputs into the data processing system 305 (e.g., function identifiers or API calls, parameters 335 or other inputs to the function call mapper 420) in a form, format or language of such function(s). AI assistant 410 can communicate with the client device 310 via a chatbot interface 405.

The AI assistant 410 can generate prompts 325 or facilitate generating of the prompts 325 for the GAI model. The AI assistant 410 can generate the prompts 325 based on any portion of the query 402 and API responses 430. The AI assistant 410 can incorporate placeholders and templates for form creation, implement or input parameters 335 in their appropriate locations or fields and utilize GAI model 350 to process the prompt 325 (e.g., generated based on the API responses 430) to generate computer code that structures form elements according to predefined templates 365. The AI Assistant 410 can facilitate maintaining operation of the GAI model 350 within a defined operational context (e.g., provided by API responses 430 and query 402 information), improving (e.g., narrowing) the probability distribution of the result around the target response, thereby improving the accuracy of generated code for automated form creation.

Chatbot interface 405 can include any user-facing interface that allows users to interact with the AI assistant 410 using natural language (e.g., text prompt from the client device 310). The chatbot interface 405 can include a text-based or a voice-based interface for receiving queries from client devices and providing responses to the queries to the client devices. The chatbot interface 405 can receive query 402, send it to the AI assistant 410 for processing. The chatbot interface can provide for display on a client device 310 any responses (e.g., 365 or 385) from the AI assistant 410, that may be responsive to the query 402. Chatbot interface 405 can interact with the users to identify placeholders 330 and templates 365 for form generation. Chatbot interface 405 can integrate with the AI assistant 410 to provide prompt responses based on user interactions or inputs.

Function call mapper 420 can include any combination of hardware and software that selects or maps the functions identified or function calls generated by the AI assistant 410 or GAI model 350. Function call mapper 420 can identify the specific API endpoints (e.g., API functions 425) to call (e.g., via API call) based on the information from the AI assistant 410 identifying the API function 425 based on the function identifying information from the GAI model 350. Function call mapper 420 can extract parameters 335 and operation identifier from the function calls and can execute the API requests by issuing API calls to the identified API functions 425. Function call mapper 420 can receive function calls from the AI interface 410, such as calls for API operations translated or reformed by the AI assistant 410 into API requests that execute specific tasks.

API functions 425 can include any functions (e.g., API endpoints) performing specific operations defined within an API. API functions 425 can include computer code, sets of instructions or executable code that can be configured to be executed to perform various tasks or retrieve data. API functions 425 can include operations such as retrieving employee details, updating records, or processing transactions. API functions 425 can retrieve an employee's name, address, and job title based on a provided employee ID. The API converter 440 can convert API specifications into API functions 425, allowing the system to perform specific actions based on user input or instructions from GAI model 350 or AI assistant 410.

Each API function 425 can be mapped by the function call mapper 420 which can extract inputs or parameters 335, such as employee information (e.g., employee ID, status, input values for the form). API functions 425 can be executed based on the API requests and generate output API responses 430 that can be used to create a prompt 325 (e.g., by the AI assistant 410) to provide the output (e.g., 365 or 385), such as a computer code in accordance with the template 365.

Result processor 435 can include any combination of hardware and software, such as a function or a module, which receives the API responses 430 and processes them into a format suitable for the AI assistant 410. Result processor 435 can extracts relevant information from the API responses 430 and sends extracted information to the AI assistant 410 to use for generating the prompt 325. For instance, the result processor 435 can analyze API responses 430 to refine data for integration into the AI assistant's context, such as by providing portions of the API responses 430 (e.g., section of code executed for a given template 365 or form 385) to be used by the AI assistant 410 as an input (e.g., prompt 325) into the GAI model 350 to generate the intended results.

Tuning dataset 450 can include any dataset for training, tuning or adjusting the operation of the AI assistant 410. Tuning dataset 450 can be stored in a storage 120. Tuning dataset 450 can include information or data on API-related tasks and their corresponding function calls. Tuning dataset 450 can be used to adjust or configure the operation of (e.g., fine-tune) the AI assistant 410, allowing the AI assistant 410 to generate accurate and reliable function calls, function data 415 or prompts 325, based on the information available, such as query 402, function identifier, API calls, or API responses 430. Tuning dataset 450 can be used to train the AI assistant 410 or the GAI model 350 to determine API-related tasks from function calls and vice versa.

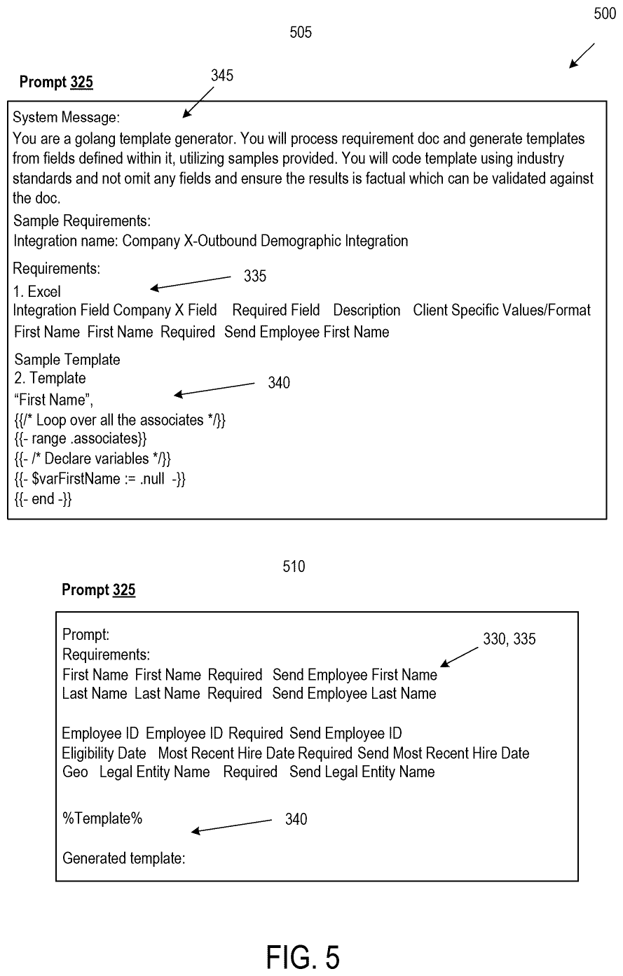

FIG. 5 illustrates example views 505 and 510 of contents of prompts 325. View 505 illustrates a prompt 325 that can be used as an input into a GAI model 350. The prompt 325 of view 505 can include example parameters 335, template samples 340 and instructions 345. The prompt 325 can include a message (e.g., instructions 345, placeholders 335) to the GAI model 350 informing the GAI model 350 that it is a Golang template generator that will process requirement documents and generate templates from fields defined, using the samples provided. Prompt 325 can provide sample requirements, which can indicate or reference a company name or other data, a format of a document and placeholders and parameters, such as “integration field”, “description”, “first name”, “last name” and others. Prompt 325 can include a template sample 340 referencing a first name and placeholders (e.g., Golang actions) that can be defined within double brackets or any other syntax, depending on the computer language the prompt 325 instructs the GAI model 350 to use.

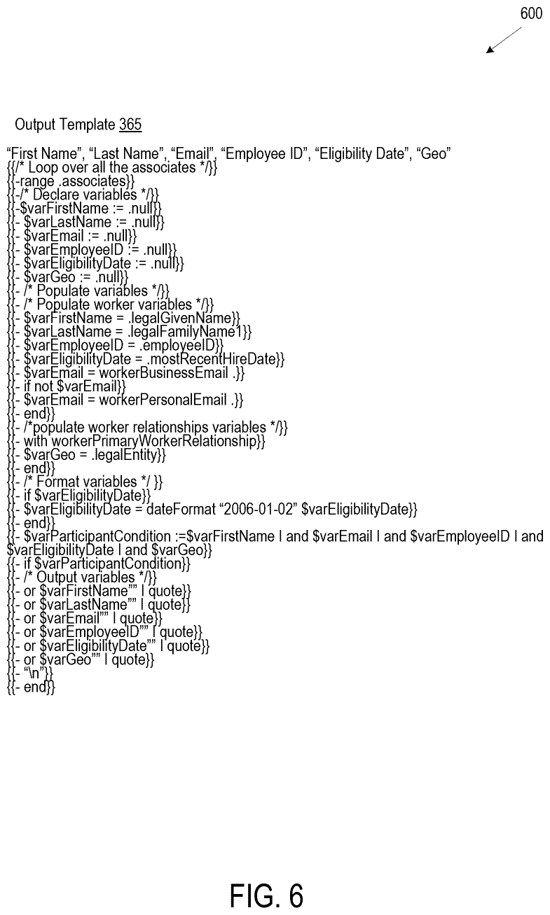

Example view 510 of FIG. 5 illustrates another example of a prompt 325 that can be used as an input into a GAI model 350. Prompt 325 of example view 510 can include a list of “requirements” that can include various placeholders 330 and parameters 335 that the output template 365 is expected to include. The prompt 325 of example view 510 can be used to produce, for example, an output template 365 of example 600 in FIG. 6.

FIG. 6 relates to an example 600 of an output template 365 that can be provided or used, in accordance with aspects of the technical solutions. The output template 365 can include computer code (e.g., Golang computer code) produced by the GAI model 350 responsive to, based on, or according to the prompt 325 that can be input into the GAI model 350. For instance, output template 365 of example 600 can be used by an AI assistant 410 to cause the GAI model 350 to operate within a probability distribution 355 and within the context 360 defined, specified, adjusted or created according to prompt 325.

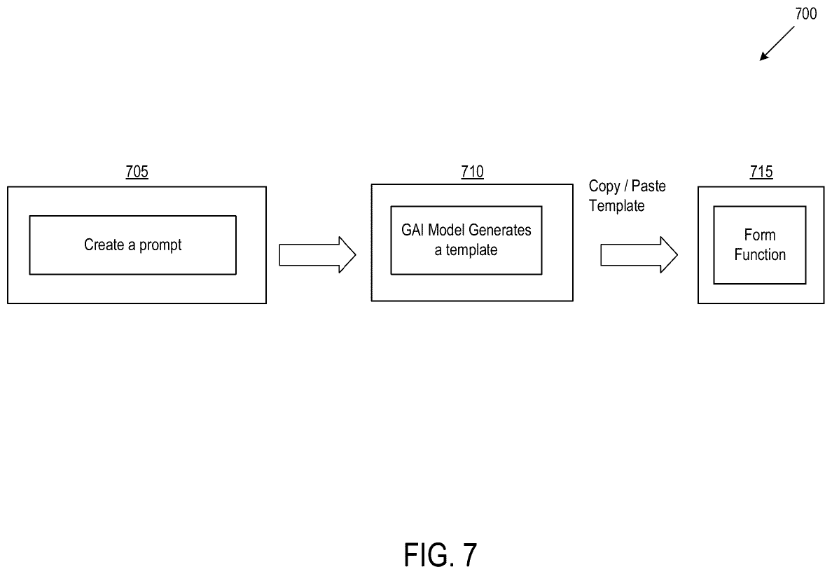

FIG. 7 relates to an example process flow 700 for prompt-based conditioning of a GAI model to produce a GAI model generated computer code for automated formation of templates, in accordance with aspects of the technical solutions. The process flow 700 can be performed by one or more systems, features, techniques or components depicted herein, including, for example, a system 300 or a data processing system 305 of FIGS. 3-4. At 705, the process flow can include a data processing system generating a prompt for a GAI model. The data processing system can generate the prompt using, for example, AI assistant generating function data 415 and parameters. The data processing system can generate the prompt based on the API responses from API functions called by the AI assistant or the function call mapper.

At 710, the process flow can include the data processing system utilizing the GAI model to generate a template. For instance, the AI assistant can generate a prompt based on API responses from API functions executed responsive to user input information. The template can include the output template having or include code or instructions for forming the form.

At 715, the process flow can include the form function providing a form. The data processing system can include and utilize the form function to generate the form based on the output template received from the AI assistant (e.g., GAI model). The form function can generate a form populated using parameters and placeholders for each entry.

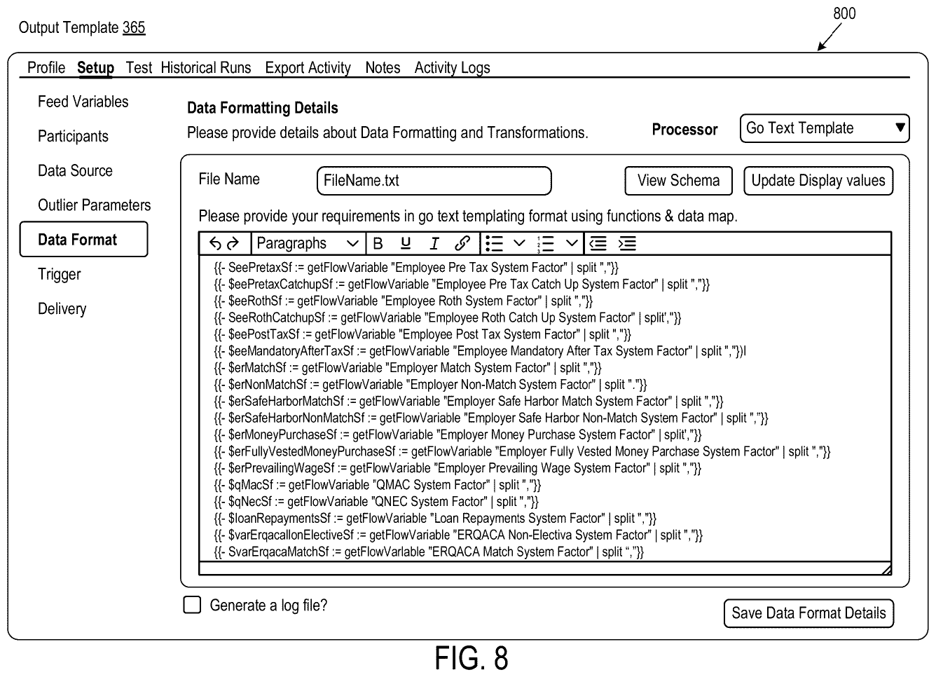

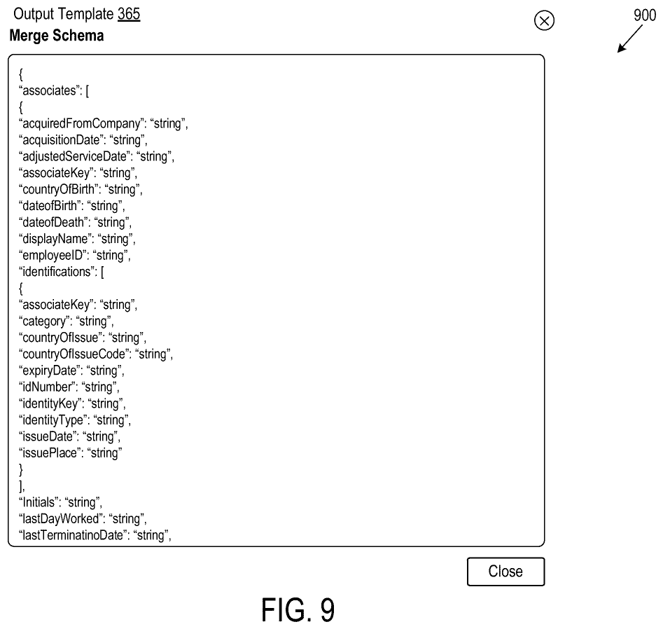

FIGS. 8-9 relate to examples 800 and 900 of output templates 365, in accordance with aspects of the technical solutions. The examples 800 and 900 of the output templates 365 can include computer code or scripts defining various parameters, placeholders and other components of the form. Examples 800 and 900 also provide an example of a user interface 315 (e.g., a graphical user interface or GUI) of an application that allows the user to edit the contents of the computer code or scripts, modify or define parameters, placeholders or any other information or contents.

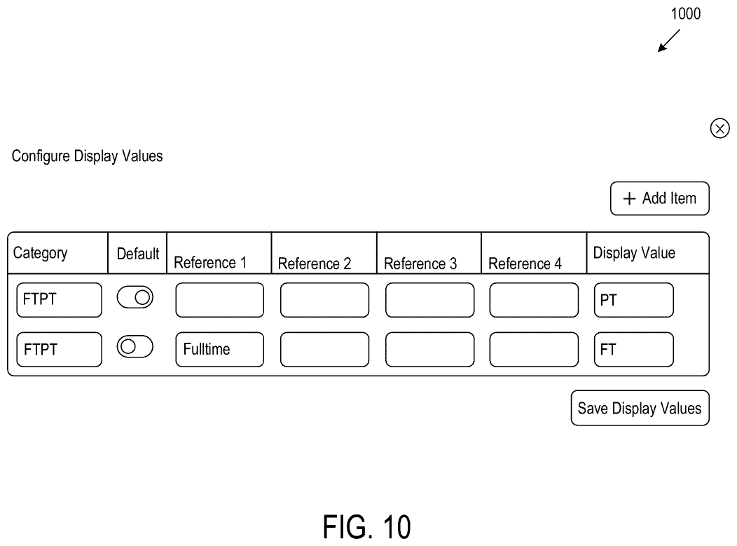

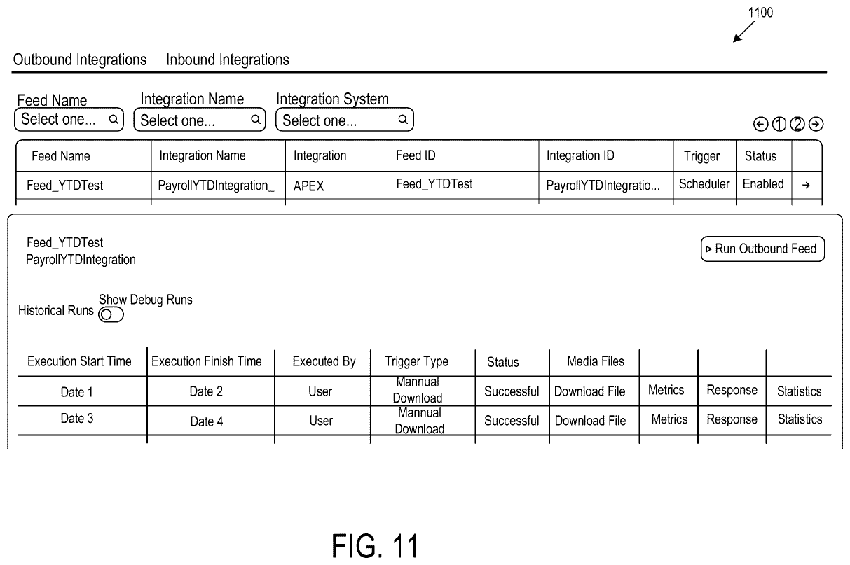

FIGS. 10-11 relate to examples of user interfaces 315 and corresponding data inputs, in accordance with aspects of the technical solutions. The user interface 315 of example 100 can include a graphical user interface (GUI) allowing the user to enter, define and save various parameters (e.g., reference or display values) that can be displayed in the GUI. The user interface 315 of example 110 can include menu buttons or selections for the user to select to configure various aspects of the form to be generated, including integration names, historical data and the type of data to be used.

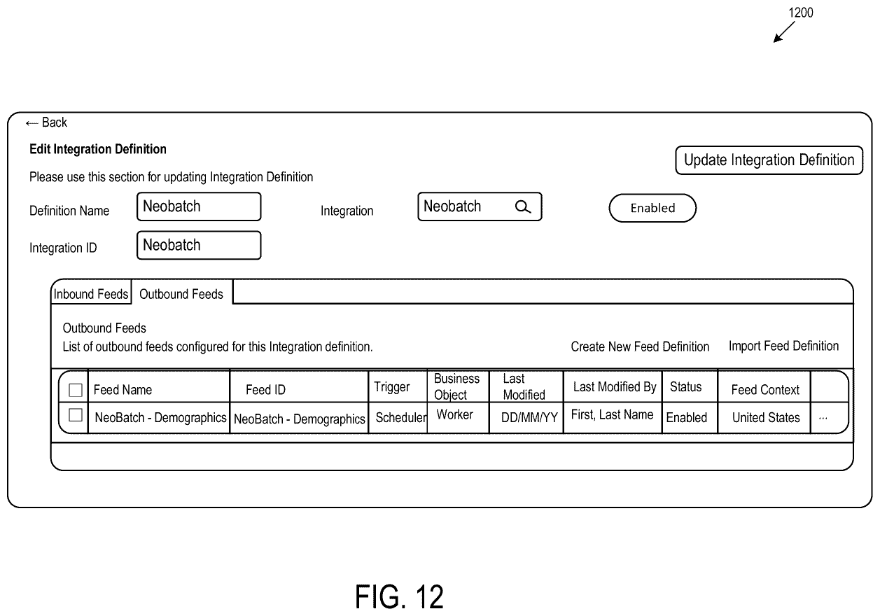

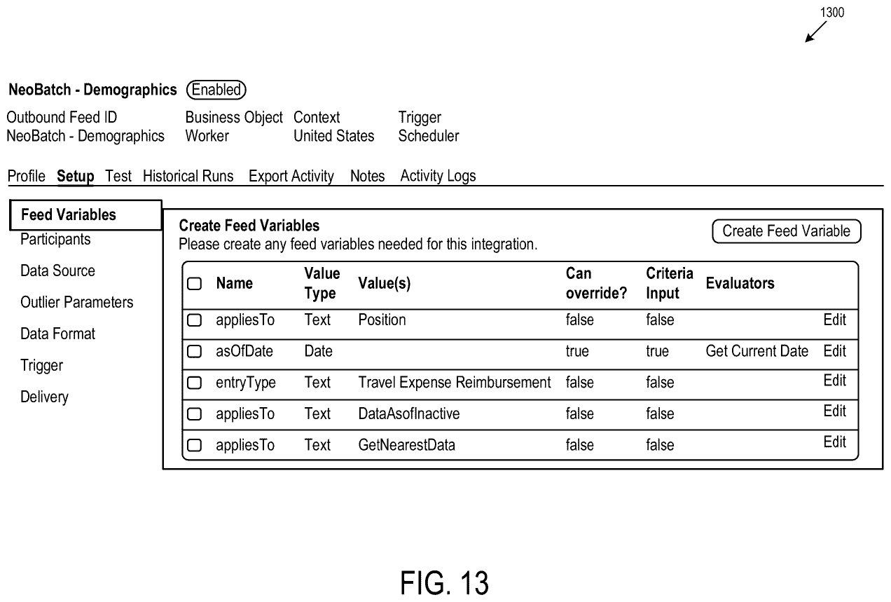

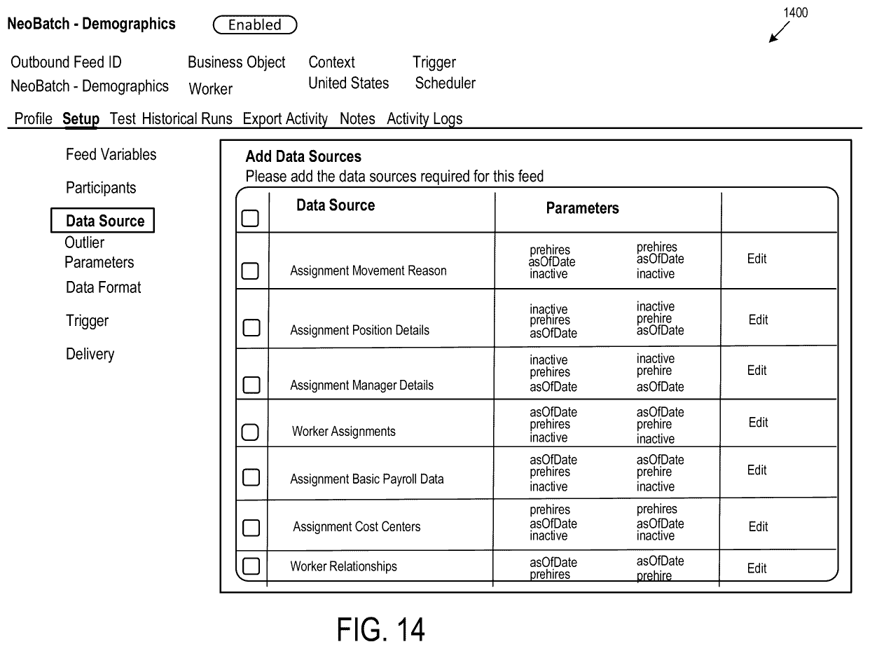

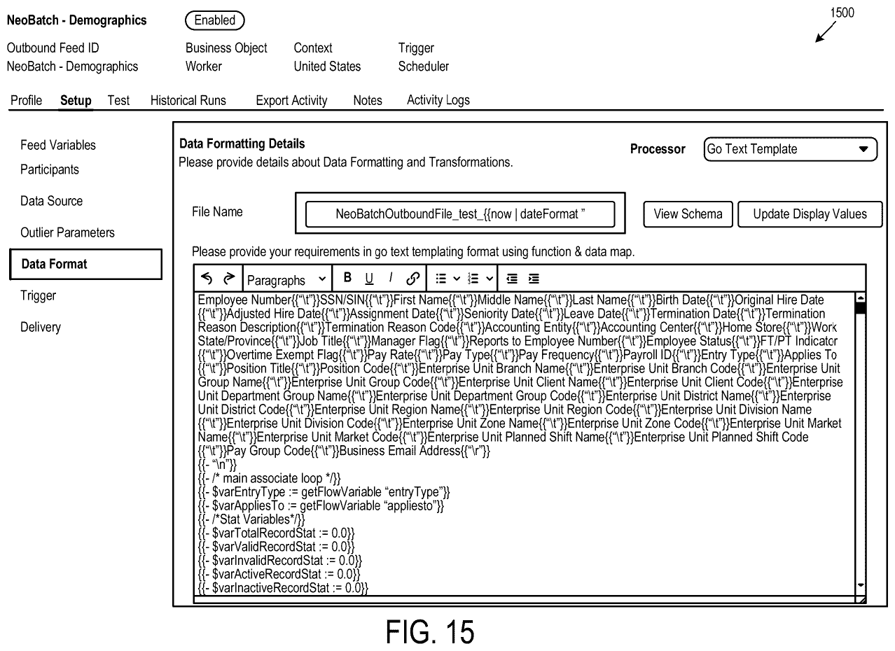

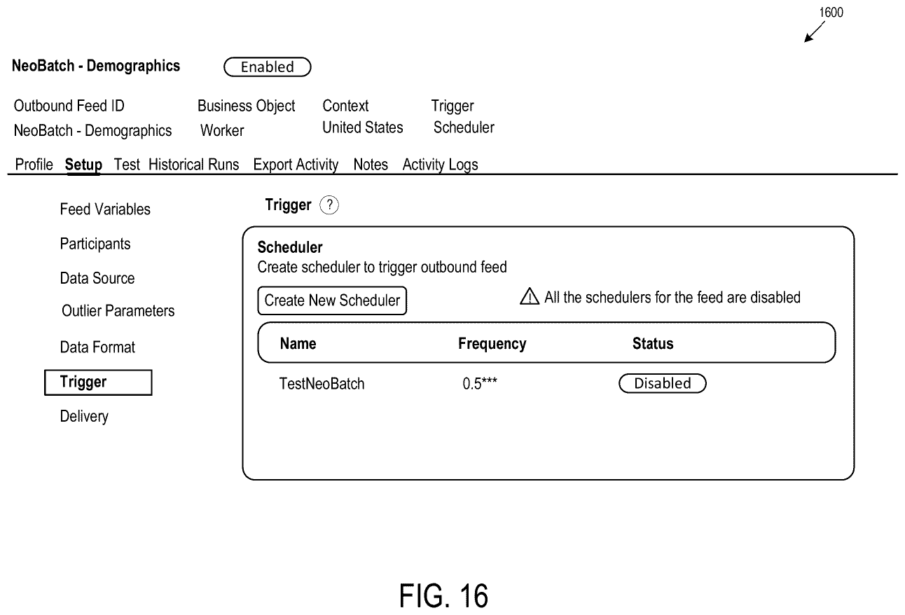

FIGS. 12-16 illustrate various examples 1200-1600 of user interfaces 315 of an application for a data processing system allowing the user to create or edit various values or parameters for the prompt-based GAI model conditioning using AI assistant and APIs. FIG. 12 illustrates an example 1200 of a user interface 315 of an application allowing the user to create or edit of various API functionalities (e.g., as discussed in example 400 of FIG. 4), such as the entries on integration or feed of data for a person for which the form is generated. FIG. 13 illustrates an example 1300 of a user interface 315 of an application allowing the user to create or edit of various feed variables (e.g., type of value or type of form). FIG. 14 illustrates an example 1400 of a user interface 315 of an application allowing the user to create, edit or delete various data sources to be used in feed variables. FIG. 15 illustrates an example 1500 of a user interface 315 of an application allowing the user to create or edit of data format for the template to be output by the system. FIG. 16 illustrates an example 1600 of a user interface 315 of an application allowing the user to create or edit of the trigger and delivery of the output of the data processing system.

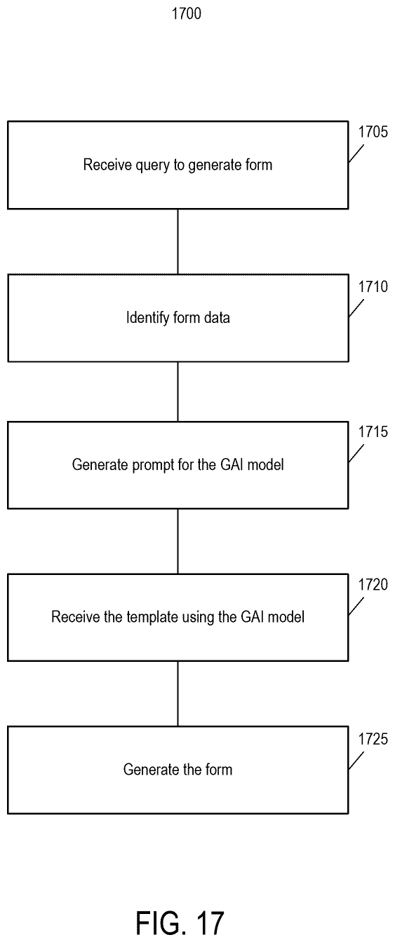

FIG. 17 illustrates a flow diagram of a method 1700 for providing prompt-based conditioning of a generative alternative intelligence (GAI) model for automated generation of forms. The method 1700 can be performed by one or more systems, features, techniques or components depicted in FIGS. 1-16, including, for example, a system 300 or a data processing system 305 of FIGS. 3-4. The data processing system 305, or its functionalities, can be implemented using one or more processors 115 configured to perform the functionalities of the data processing system 305 based on instructions, computer code or data stored on memory or storage (e.g., 120 or 125) of a computing system 100. At a high level, method 1700 can include acts 1705-1725. At 1705, the method can include receiving a query to generate a form. At 1710, the method can include identifying form data. At 1715, the method can include generating prompt for the GAI model. At 1720, the method can include receiving the template using the GAI model. At 1725, the method can include generating the form.

At 1705, the method can include receiving a query to generate a form. The query can be a query from a client device. The query can be received by a chatbot interface of a data processing system. The chatbot interface can be provided by an application accessible by the client device to allow a user to set up, interact or configure functionalities of a data processing system.

The query can include information about the type of form to generate or a type of an entity, a user or person for which or whom to generate the form. The query can include any parameters or values corresponding to the form, such as values for various form entries or placeholders, conditions for filling out the form entries, or any information about entries or placeholders. The query can include information on, or about, the template sample, including information on computer code, type of language to use, format of the code, values or variables for the code, or a code sample.

At 1710, the method can include identifying form data. The method can include the data processing system identifying one or more placeholders for one or more parameters of a form. The method can include the data processing system identifying a sample of a template for the form. The method can identify any feature, information or data from the query that can be indicative or used for generating a prompt or otherwise inform the GAI model of the type of computer code or form to generate.

The method can include the data processing system generating, using an AI assistant for the GAI model and based on the query received at 1705, the one or more placeholders and the sample of the template for the GAI model. For instance, the AI assistant can provide the query, or a portion of the query, to the GAI model. The GAI model can identify, from the query (e.g., or a portion of the query), information about the form.

The AI assistant can generate and provide to the GAI model (e.g., along with the query information) one or more function data or information. The function data can include data or information on all of the external API functions available to the GAI model for the particular request. For example, the AI assistant can process the query to filter out one or more API functions that are not available or suitable for the type of query or form the query is describing or requesting. The AI assistant can provide function data of all the API functions that are available to the GAI model (e.g., excluding the filtered-out API functions).

At 1715, the method can include generating prompt for the GAI model. The method can include the data processing system generating a prompt for the GAI model. The prompt can indicate (e.g., include information on) the one or more placeholders for the one or more parameters. The prompt can indicate or include the sample (e.g., of the computer code). The prompt can indicate or include an instruction to condition a probability distribution of the GAI model. The instruction can condition to probability distribution of the GAI model such that it causes the GAI model to generate the computer code for providing the form that arranges the placeholders in accordance with the template.

The computer code can include one or more computer instructions, keywords or parameters implemented using at least one computer language. The computer language used or included can be any one or more of: Goland (Go) programing language, hypertext markup language (HTML), cascading style sheets (CSS), JavaScript language, Python programming language, Ruby programming language, Java programming language, C sharp (C#) programming language and PHP: Hypertext Processor (PHP) scripting language. The prompt can identify a computer language for the computer code to cause the GAI model to provide the computer code in the identified computer language.

The prompt can identify the one or more placeholders for the one or more parameters of an employee of the enterprise. The one or more parameters can be indicative of confidential information of the employee or an enterprise (e.g., organization, company or a corporation). The one or more parameters can be indicative of data (e.g., values or entries on various portions of the form) corresponding to an employee or an enterprise.

The instruction of the prompt can define or describe a context of the GAI model to adjust the probability distribution to cause the GAI model to generate the computer code according to content of the prompt. The prompt can include a set of requirements listing the one or more placeholders and for each of the one or more placeholders identifying a corresponding parameter of the one or more parameters. The prompt can be configured to set the probability distribution of the GAI model to cause the GAI model to generate, in the computer code, a series of instructions to define the form.

At 1720, the method can include receiving the template using the GAI model. The method can include the data processing system receiving, from the GAI model, the computer code for providing the form. The computer code can include the placeholders for the one or more parameters arranged in accordance with the template. The computer code can include the placeholders and parameters arranged based on the API responses from the API functions executed by the data processing system. The API responses or the information about the API responses can be included in the prompt by the AI assistant. The API responses can include portions of the computer code or instructions about specific sections of the computer code that the GAI model can utilize to generate the computer code (e.g., the template).

The method can include the data processing system receiving, from the GAI model, the computer code responsive to the API response and the prompt input into the GAI model. The API responses can include responses of the API functions selected based on a function identifier generated by the GAI model in response to a query and function data provided by the AI assistant to the GAI model. For example, a data processing system can receive, using the AI assistant for the GAI model, identifier of an API function of a plurality of API functions. The identifier can include a function identifier generated by the GAI model in response to a query and function data input into the GAI model. The data processing system can generate, by executing one or more API functions using the one or more parameters, one or more API responses from such API functions. The API functions can be mapped or selected by the function call mapper based on the function identifier. The API responses can include information or data to be included within, or along with, the prompt, to the GAI model. For example, an AI assistant can provide one or more API responses or data from the one or more API responses provided by the result processor along with the prompt. The GAI model can utilize both the API responses and the prompts to generate the output (e.g., template of the computer code or the form).

At 1725, the method can include generating the form. The method can include the data processing system generating the form according to the computer code. The data processing system can include and utilize a form function to generate the form using the output template of the form. The data processing system can utilize the GAI model to generate the form, using the output template as the input. For example, the data processing system can utilize the API responses and the prompt (e.g., from operation 1720) to generate either the computer code of the output template or the form itself. The form can be completed and include data entries populated in their corresponding fields. The form can be provided to the client device via a user interface, such as a graphical user interface. The form can be provided to the client device via a chatbot interface in response to the query from the client device to generate the form.

The foregoing examples have been provided merely for the purpose of explanation and are in no way to be construed as limiting of the technical solutions. While aspects of the present disclosure have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system comprising:
one or more processors, coupled with memory, to:
identify one or more placeholders for one or more parameters of a form;
identify a sample of a template for the form;
generate, for a generative artificial intelligence (GAI) model, a prompt indicating the one or more placeholders for the one or more parameters, the sample and an instruction to condition a probability distribution of the GAI model to cause the GAI model to generate a computer code for providing the form that arranges the placeholders in accordance with the template; and
receive, from the GAI model, the computer code for providing the form comprising the placeholders for the one or more parameters arranged in accordance with the template.

2. The system of claim 1, further comprising the one or more processors to:
receive, by a chatbot interface, a query; and
generate, using an AI assistant and based on the query, the one or more placeholders and the sample of the template for the GAI model.

3. The system of claim 2, further comprising the one or more processors to:
receive, using the AI assistant, an identifier of an API function of a plurality of API functions; and
generate, by executing the API function using the one or more parameters, an API response.

4. The system of claim 3, further comprising the one or more processors to:
receive, from the GAI model, the computer code responsive to the API response and the prompt input into the GAI model.

5. The system of claim 1, wherein the instruction of the prompt defines a context of the GAI model to adjust the probability distribution of the GAI model to cause the GAI model to generate the computer code according to content of the prompt.

6. The system of claim 1, further comprising the one or more processors to generate the form according to the computer code.

7. The system of claim 1, wherein the prompt includes a set of requirements listing the one or more placeholders and for each of the one or more placeholders identifying a corresponding parameter of the one or more parameters.

8. The system of claim 1, wherein the prompt is configured to set the probability distribution of the GAI model to cause the GAI model to generate, in the computer code, a series of instructions to define the form.

9. The system of claim 1, wherein the computer code includes one or more computer instructions, keywords or parameters implemented using at least one computer language including: Goland (Go) programing language, hypertext markup language (HTML), cascading style sheets (CSS), JavaScript language, Python programming language, Ruby programming language, Java programming language, C sharp (C#) programming language and PHP: Hypertext Processor (PHP) scripting language.

10. The system of claim 1, wherein the prompt identifies a computer language for the computer code to cause the GAI model to provide the computer code in the identified computer language.

11. The system of claim 1, wherein the prompt identifies the one or more placeholders for the one or more parameters of an employee of the enterprise, the one or more parameters indicative of confidential information of the employee.

12. A method comprising:
identifying, by one or more processors coupled with memory, one or more placeholders for one or more parameters of a form;
identifying, by the one or more processors, sample of a template for the form;
generating, by the one or more processors for a generative artificial intelligence (GAI) model, a prompt indicating the one or more placeholders for the one or more parameters, the sample and an instruction to condition a probability distribution of the GAI model to cause the GAI model to generate a computer code for providing the form that arranges the placeholders in accordance with the template; and
receiving, by the one or more processors from the GAI model, the computer code for providing the form comprising the placeholders for the one or more parameters arranged in accordance with the template.

13. The method of claim 12, comprising:
receiving, by the one or more processors, via a chatbot interface for the GAI model, a query; and
generating, by the one or more processors using an AI assistant for the GAI model and based on the query, the one or more placeholders and the sample of the template for the GAI model.

14. The method of claim 13, comprising:
receiving, by the one or more processors, using the AI assistant for the GAI model, identifier of an API function of a plurality of API functions; and
generating, by the one or more processors, by executing the API function using the one or more parameters, an API response.

15. The method of claim 14, comprising:
receiving, by the one or more processors, from the GAI model, the computer code responsive to the API response and the prompt input into the GAI model.

16. The method of claim 12, comprising:
defining, by the one or more processors in the instruction of the prompt, a context of the GAI model by adjusting the probability distribution to cause the GAI model to generate the computer code.

17. The method of claim 12, comprising:
generating, by the one or more processors, the form according to the computer code.

18. The method of claim 12, comprising:
including, by the one or more processors within the prompt, a set of requirements listing the one or more placeholders; and
identifying, by the one or more processors for each of the one or more placeholders, a corresponding parameter of the one or more parameters.

19. The method of claim 12, wherein the prompt is configured to set the probability distribution of the GAI model to cause the GAI model to generate, in the computer code, a series of instructions to define the form.

20. A non-transitory computer readable medium storing program instructions for causing at least one processor to:
identify one or more placeholders for one or more parameters of a form;
identify a sample of a template for the form;
generate, for a generative artificial intelligence (GAI) model, a prompt indicating the one or more placeholders for the one or more parameters, the sample and an instruction to condition a probability distribution of the GAI model to cause the GAI model to generate a computer code for providing the form that arranges the placeholders in accordance with the template; and
receive, from the GAI model, the computer code for providing the form comprising the placeholders for the one or more parameters arranged in accordance with the template.
